(19) United States
(12) Patent Application Publication
(10) Pub. No.: US 2004/0191723 A1
(43) Pub. Date: Sep. 30, 2004

(54) Endodontic instrument

(76) Inventors: Dane L. Shearer, York, PA (US); Jack L. Shearer, York, PA (US); Lonnie M. Graybill, York, PA (US)

Correspondence Address: JONES DAY, 222 EAST 41ST ST, NEW YORK, NY, 10017, US

(21) Appl. No.: 10/403,400

(22) Filed: Mar. 31, 2003

(51) Int. Cl. A61C 5/02; B21F 43/00

(52) U.S. Cl. 433/102; 29/896.11

(57) ABSTRACT

An endodontic instrument for use in performing root canal therapy on a tooth having at least one straight flute which prevents self-threading or screwing of the instrument into a root canal during use. The instrument includes a shaft having a longitudinal central axis, a shank portion and an elongated working portion extending from the shank portion along the central axis, the elongated working portion having a proximal end, a distal end, and at least one peripheral surface and at least one straight flute formed on at least a portion of the peripheral surface of the working portion, the straight flute forming at least one cutting edge on the peripheral surface. The straight flute may be formed of a plurality of flute sections disposed on the peripheral surface of the instrument, the plurality of flute sections angularly displaced about the central axis with respect to one another. A method of manufacturing an endodontic instrument is also disclosed.

### FIELD OF THE INVENTION

The present invention relates to endodontic instruments and the manufacture of such instruments.

### BACKGROUND OF THE INVENTION

When a tooth decays to the point where the inner nerves and roots become infected, dentists must oftentimes perform a root canal procedure in order to save the tooth and prevent further infection. The primary goal of a root canal is to remove all of the decayed or injured nerve while leaving the integrity of the root canal walls relatively unaffected. Preserving the integrity of the root canal is important in order to allow proper filling of the root canal such that leakage or communication between the root canal system and the surrounding and supporting tissues of the tooth is prevented.

To perform a root canal procedure, the endodontist first drills into the tooth to locate the root canal. Endodontic instruments, commonly referred to as files and reamers, are then used to clean and enlarge the root canals of the tooth. The purpose of the cleaning and enlarging procedure is to remove dead, decayed, or infected tissue from the root canals and to enlarge the root canals so that they can be filled. The reamers and files can either be finger manipulated or engine driven by the endodontist, e.g., rotary, oscillating, reciprocating, etc., and are typically of small diameter to allow them to be used in the small working environment of the root canal.

Traditional endodontic files and reamers have always employed helical flutes. The common perception was that endodontic files and reamers, whether finger manipulated or engine driven, basically perform in a rotating drill-like or reamer-like fashion and thus must have helical flutes to allow evacuation of the debris generated by the cutting action of the instrument. The build-up of debris between the flutes of the instrument and the canal walls can cause damage to the canal walls and/or lead to failure of the instrument. Therefore, during the root canal procedure it is important to evacuate the debris adequately as the file or reamer enlarges the root canal and progresses toward its apex.

One problem associated with helical fluted endodontic instruments involves the instrument self-threading or screwing into the canal. This is because helical flutes have continuous helically oriented cutting edges that dig in and thread or screw into the canal. This self-threading propensity of helically fluted instruments is a major undesirable operational characteristic that is a leading cause of instrument breakage. Many modifications of helical fluted instruments have been employed to address this drawback. Some of these modifications include varying the helical angles, varying the pitch, radial lands, and passive rake angles. However, only limited operational improvement has been evident with these modifications. Therefore, a need exists for an endodontic instrument that cuts efficiently and adequately removes debris but at the same time does not self-thread into the canal.

Furthermore, current practices used to grind endodontic instruments with conventional helical flutes require the rotation of the stock about its axis as it passes axially by a rotating grinding wheel. These current practices involve separate operations and separate machines for the grinding of the flutes in the raw material and the grinding of the outside diameter and taper of the instrument. Therefore, a need exists for a more efficient method of making an endodontic instrument that does not self-thread into the canal.

### SUMMARY OF THE INVENTION

In a preferred embodiment, the present invention relates to an endodontic instrument for use in performing root canal therapy on a tooth. The instrument comprises a shaft having a longitudinal central axis, a shank portion and an elongated working portion extending from the shank portion along the central axis. The elongated working portion has a proximal end, a distal end, and at least one peripheral surface. At least one straight flute is formed on at least a portion of the peripheral surface of the working portion, the straight flute forming at least one cutting edge on the peripheral surface. The working portion of the instrument may be non-tapered or either uniformly or non-uniformly tapered. The straight flute may be substantially parallel to the central axis, and the cutting edge may have a negative rake angle, a neutral angle, or a positive rake angle. In an alternate preferred embodiment, the straight flute and/or the cutting edge may be oriented at an angle α with respect to the central axis. In still another preferred embodiment, the instrument may further comprise at least one helical flute formed on the peripheral surface of the working portion adjacent the at least one straight flute.

The at least one straight flute may comprise a plurality of flute sections disposed on the peripheral surface of the instrument, the plurality of flute sections angularly displaced about the central axis with respect to one another and each flute section having first and second ends defined along the central axis. In one preferred aspect, a first end of a first flute section is disposed along the longitudinal central axis between the first and second ends of a second flute section such that the first and second flute sections overlap longitudinally along the central axis. A gate may be formed where the first and second flute sections overlap longitudinally to facilitating evacuation of cutting debris up the flute. The plurality of flute sections may each further comprise first and second end surfaces with an intermediate surface disposed therebetween, the end surfaces each disposed in a plane transverse to the intermediate surface. The at least one end surface may be generally perpendicular to the intermediate surface, or, alternatively, may be disposed at an angle θ greater than 90° from the intermediate surface.

In another preferred embodiment, the second end of one of the flute sections is substantially adjacent the first end of another of the flute sections. In still another preferred embodiment, a non-fluted intermediate section is disposed between the at least two flute sections. In yet another preferred embodiment, the cutting edge includes at least one notch, which may be provided by a helical groove formed along at least a portion of the working portion or at least one circular or circumferential groove formed along at least a portion of the working portion.

In another preferred embodiment, the present invention relates to a method of manufacturing an endodontic instrument for use in performing root canal therapy on a tooth. First, wire stock is fed into custom support tooling to form a shaft having a longitudinal central axis, a shank portion and an elongated working portion extending from the shank portion along the central axis, the elongated working portion having a proximal end, a distal end, and at least one peripheral surface. At least one straight flute is grinded into at least a portion of the peripheral surface of the working portion, the straight flute forming at least one cutting edge on the peripheral surface. The diameter, taper, and finish of the instrument is grinded, and the finished instrument is parted from the stock. The step of grinding the diameter, taper, and finish of the instrument may be performed by one or more grinding wheels, and the step of grinding the at least one straight flute into the instrument is performed by the same or an additional grinding wheel.

### BRIEF DESCRIPTION OF THE DRAWINGS

FIG. 1 is a side elevational view of the instrument according to the present invention;

FIG. 2 is an enlarged cross-sectional view of the instrument taken along line A-A of FIG. 1;

FIG. 3 is another exemplary enlarged cross-sectional view of the present invention;

FIG. 4 is another exemplary enlarged cross-sectional view of the present invention;

FIG. 5 is a side elevational view of another exemplary instrument according to the present invention;

FIG. 6 is a side elevational view of another exemplary instrument according to the present invention;

FIG. 7 is an enlarged elevational view of“Detail A” shown in FIG. 6;

FIG. 8 is a side elevational view of an exemplary instrument according to the present invention;

FIG. 9 is an enlarged elevational view of “Detail B” shown in FIG. 8;

FIG. 10 is a side elevational view of another exemplary instrument according to the present invention;

FIG. 11 is an enlarged cross-sectional view of the instrument taken along line B-B of FIG. 10;

FIG. 12 is an enlarged cross-sectional view of the instrument taken along line C-C of FIG. 10;

FIG. 13 is an enlarged cross-sectional view of the instrument taken along line D-D of FIG. 10;

FIG. 14 is a side elevational view of another exemplary instrument according to the present invention; and

FIG. 15 is a side elevational view of yet another exemplary instrument according to the present invention.

### DETAILED DESCRIPTION OF THE PREFERRED EMBODIMENTS

The present invention relates to an improved endodontic instrument for use in performing root canal therapy on a tooth. In practice, endodontic files and reamers, whether finger manipulated or engine driven, are not normally used in a traditional drill or reamer like fashion. More specifically, endodontic files and reamers are not commonly used in a manner where the instrument is continually rotated in one direction and advanced continuously forward. In reality, finger manipulated files and reamers are quite often used in a watch-winding, quarter-turn-and-pull, or hybrid-balance-force fashion. Engine driven rotary techniques commonly use peck-drill motions, which advance the file or reamer incrementally forward and then retract the instrument. Furthermore, both finger manipulated and engine driven techniques also include repeatedly retracting the file or reamer from the canal to allow irrigation and the introduction of lubricants, which enables debris to be evacuated. Moreover, all root canal techniques use multiple files or reamers of different sizes and tapers and the repeated changing of files or reamers inherently provides a mechanism to remove accumulated debris from the canal.

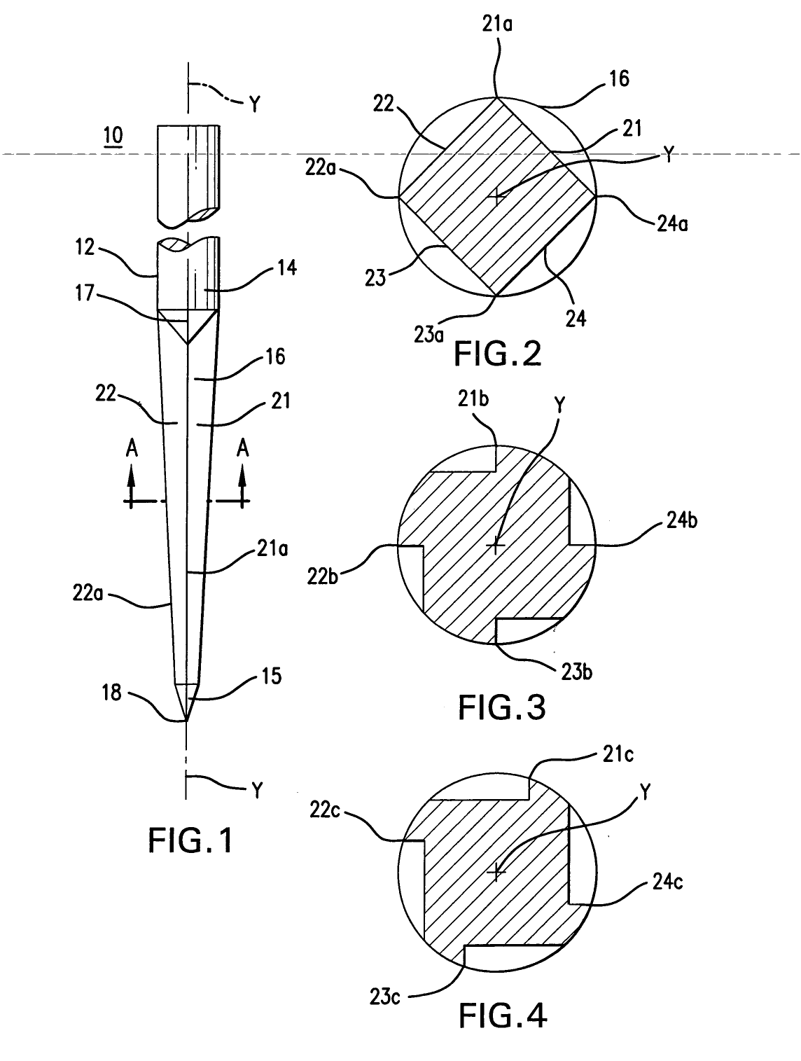

FIG. 1 illustrates an embodiment of the endodontic instrument 10 in accordance with the present invention. The instrument 10 generally comprises a shaft 12 having a shank portion 14 and an elongated working portion 16. The working portion 16 extends from a proximal end 17 adjacent the base of the shank 14 to a distal end 18 terminating in a tip 15. The shank 14 may include an optional fitting portion (not shown) for mating with the chuck of a dental hand piece (not shown). Alternatively, or in addition to a fitting portion, the shank portion 14 may include a knurled or otherwise treated surface (not shown) or handle to facilitate hand manipulation of the file 10. The endodontic instruments described herein may be used by finger manipulation, or the instruments may be engine driven by attaching the shank portion of the instrument to a motorized hand piece.

As shown in FIGS. 1 and 2, in a preferred embodiment, the endodontic instrument 10 includes four straight flutes 21, 22, 23, and 24 formed in the working portion 16, extending parallel to the central axis Y of the instrument from the distal end 18 adjacent the tip 15 and exiting at the proximal end 17. As shown in FIG. 2, which is a cross-section through working portion 16 of instrument 10, the four flutes 21, 22, 23, and 24 form cutting edges 21a, 22a, 23a, and 24a on the working portion 16. This straight flute concept solves the problem of self-threading of the instrument into the canal because there are no continuous helically oriented cutting edges to dig in and thread or screw into the canal. Those skilled in the art will readily appreciate that a similar instrument could also be configured with one to three straight flutes or five or more flutes, as desired. Furthermore, such flutes can extend either a portion of the length or the entire length of working portion 16.

The flutes can be formed so as to form common geometric cross-sections of working portion 16. Because a straight flute design prevents self-threading, the cross-sectional shape can be made to optimize cutting efficiency and aggressiveness. FIG. 2 shows a square cross-sectional shape of the working portion 16 of instrument 10 containing the flutes 21, 22, 23, and 24 taken along line A-A of FIG. 1. It should be noted that other cross-sectional shapes of the working portion 16 may be utilized with the present invention, the invention not being limited to a particular cross-sectional shape of the peripheral surface. These cross-sectional shapes, which may be symmetrical or asymmetrical, can include, but are not limited to substantially triangular-shaped, substantially trapezoidal-shaped, substantially semi-circular shaped, substantially d-shaped, substantially pie-shaped, and substantially c-shaped. Thus, the working portion 16 of the instrument of the present invention is not limited to a single cross-sectional shape.

Because the shape of the flute space is defined by the cross-section shape of the working portion, flutes 21, 22, 23, and 24 may have the same or different cross-sectional flute shapes. FIG. 2 shows the flute space shape being straight. It should be noted that other flute space shapes may be utilized with the present invention, the invention not being limited to a particular flute space shape. These flute space shapes can include, but are not limited to substantially s-shaped and substantially u-shaped. Thus, the flute space shape is not believed to be critical to the present invention. Furthermore, the flutes can be symmetrically or asymmetrically spaced along the peripheral surface of the working portion.

The rake angles of the cutting edges 21a, 22a, 23a, and 24a may be positive, negative, or neutral, as desired. FIG. 2 shows an example of the cross-sectional shape of the working portion 16 of instrument 10 taken along line A-A of FIG. 1, where the cutting edges 21a, 22a, 23a, and 24a have a negative rake angle. FIG. 3 shows an example of the cross-sectional shape of the working portion 16 of an instrument having a neutral rake angle of the cutting edges 21b, 22b, 23b, and 24b. FIG. 4 shows an example of the cross-sectional shape of the working portion 16 of an instrument having a positive rake angle of the cutting edges 21c, 22c, 23c, and 24c. It should be noted that other cross-sectional shapes of the working portion 16 may be utilized with the present invention to achieve the desired rake angles, the invention not being limited to a particular cross-sectional shape of the working portion 16. The rake angles of the cutting edges may also be equal to one another or they may be different such that, for example, one may be substantially positive and another may be substantially neutral or negative. The rake angle of one or more cutting edges may also vary along the length of the working portion 16.

In one preferred embodiment, the working portion 16 is uniformly tapered from the proximal end 17 to the distal end 18, as shown in FIG. 1. In other preferred embodiments, the rate of diameter taper may also be nonuniform, meaning that the rate of diameter taper changes along the length of the working portion 16. The tapering of the shaft, in addition to allowing the instrument to be used in the narrow spaces of the canal, further aids in the removal of debris generated by cutting. This is because straight flutes, when cut with the root/base of the flute substantially parallel to the file axis, have a flute space that inherently increases from the distal end 18 to the proximal end 17 of the instrument 10. As debris that is generated during cutting tends to follow the path of least resistance, it will naturally progress from the distal end 18 to the proximal end 17 of the instrument in the direction of the increasing flute space.

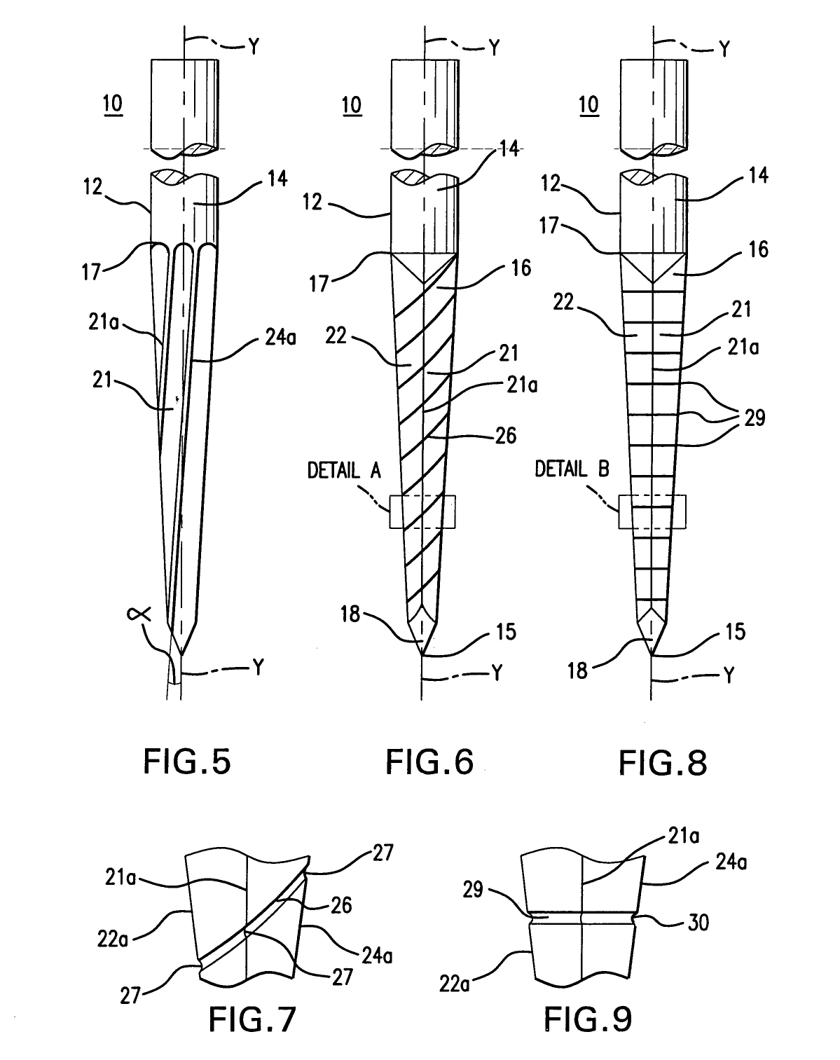

Referring to FIG. 5, the cutting edge 21a of flute 21 can be displaced on a shear angle α with respect to central longitudinal axis Y of the instrument 10, where α may range from about 0.1 degrees to about 45 degrees. This displacement further assists in the disbursement of debris up the flute of the instrument 10.

Other improvements well known in the art can be utilized along with the present invention to improve the operating characteristics of the instrument. For example, referring to FIGS. 6 and 7, a helical groove 26 can be formed in a section of the working portion 16 extending from the distal end 18 to the proximal end 17. The helical groove 26 provides notches 27 on the cutting edges 21a, 22a, 23a, and 24a, which relieve the chip load on the cutting edges, 21a, 22a, 23a, and 24a and thus allows the cutting edges 21a, 22a, 23a, and 24a to be more aggressive. Similarly, as shown in FIGS. 8 and 9, one or more circumferential grooves 29 may be formed in the working portion 16 to provide notches 30 on the cutting edges 21a, 22a, 23a, and 24a. The circumferential grooves can be evenly or unevenly spaced along the working portion from the distal end 18 to the proximal end 17.

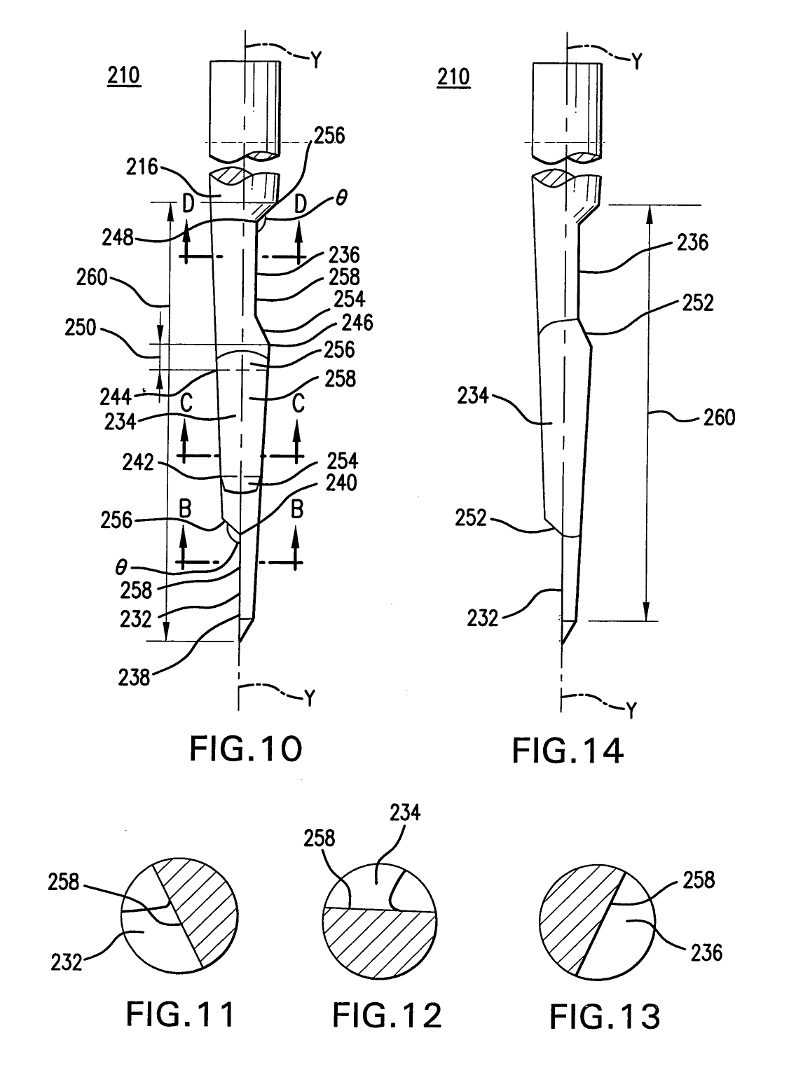

FIGS. 10-13 depict another preferred embodiment of the endodontic instrument. In this embodiment, the endodontic instrument 210 comprises one flute 221 extending along a portion of the working portion 216 disposed about the central longitudinal axis Y of the instrument, as shown in FIG. 10. The flute 221 comprises three equal length straight flute sections 232, 234, and 236, each being substantially one-third of the total flute length 260. Straight flute section 234 is disposed between straight flute sections 232 and 236. Straight flute sections 232, 234, and 236 are each angularly displaced 120° apart from each other relative to central axis Y. FIGS. 11, 12, and 13 show the cross-sectional views of the working portion 216 for straight flute sections 232, 234, and 236, taken along lines B-B, C-C, and D-D, respectively, in FIG. 10. Those skilled in the art will readily appreciate that a similar instrument could also be configured with two straight flute sections or four or more straight flute sections, as desired, and the length of the straight flute sections could be of the same or of differing lengths. Furthermore, the straight flute sections could be angularly displaced at any desirable consistent or varying angle in relation to each other.

As seen in FIG. 10, straight flute section 232 has a first end 238 and second end 240. Straight flute section 234 has a first end 242 and second end 244, and straight flute section 236 has a first end 246 and a second end 248. In a preferred embodiment, as shown in FIG. 10, there is an intermediate section 250 between the ends of portion 234 and the adjacent ends of 232 and 236. The intermediate section 250, with its greater cross-sectional area, increases the overall strength of the instrument 10, helping to prevent the breakage of the instrument 10 during use.

In another preferred embodiment, the three straight flute sections 232, 234 and 236 may be substantially adjacent to each other. In yet another preferred embodiment, as shown in FIG. 14, the three straight flute sections 232, 234 and 236 may overlap each other. The ends 242 and 244 of straight flute section 234 can also be between the first and second ends of straight flute section 232 and 236. The overlapping of straight flute sections 232 and 234 results in gate 252, which provides a path for the debris to further facilitate debris disbursal up the flute 260.

As shown in FIG. 10, the straight flute sections 232, 234, 236 each comprise first and second end surfaces 254 and 256 with an intermediate surface 258 disposed therebetween. The end surfaces 254 and 256 are each disposed in a plane transverse to the intermediate surface 258. The end surfaces 254 and 256 can be disposed at an angle θ relative to the intermediate surface 258, where θ is greater than or equal to 90°. The angular orientation of θ being greater than 90° (as shown in FIG. 10) further enhances the disbursal of the debris proximally up the flute 260.

Those skilled in the art will appreciate that in alternate embodiments, the flute segments can be shorter in length with less angular displacement between them, e.g., each section spaced 45° from the flute section before it. Other alternative embodiments may also have more than one flute, with each flute being composed of multiple flute sections.

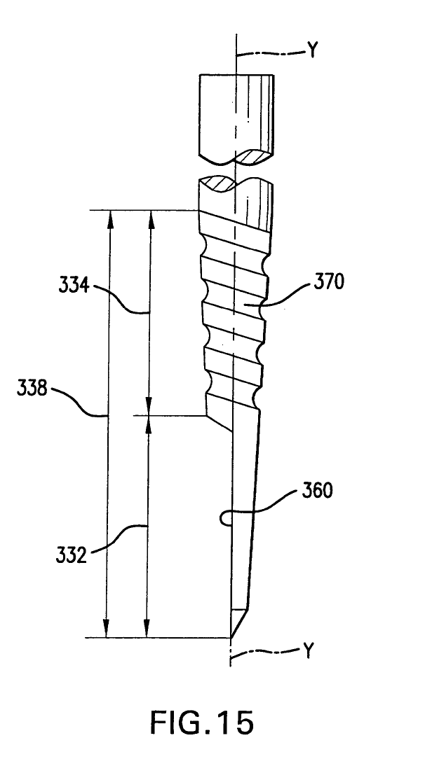

FIG. 15 depicts yet another preferred embodiment of an endodontic instrument of the present invention. In this embodiment, two equal length flute segments, 332 and 334 are shown each being one half of the total flute length 338. Flute segment 332 has a straight flute 360, while flute segment 334 has a helical flute 370. Those skilled in the art will readily appreciate that a similar instrument could also be configured with three or more flute segments as desired with at least one segment being a straight flute and another segment being a helical flute. The length of the segments could be the same or various lengths. Furthermore, the segments could be angularly displaced at any desirable consistent or varying angle.

The present invention may be produced by first grinding the non-helical flutes into the raw material and then grinding the outside diameter and taper of the instrument to the desired size, all in one operation on one machine, or on two or more separate machines. Conversely, the outside diameter and taper could be ground first, followed by the flutes. Again, these processes could all be performed on one machine, or by employing more than one machine. Furthermore, rather than just moving the part past the grinding wheel along one axis of movement, as in current methods of manufacture, the methods used in the present invention may include the movement of the grinding wheel past the part while simultaneously translating the grinding wheel in multiple axes.

In one method of manufacture the raw material can be automatically fed from blank, bar, or coil stock into custom support tooling. In a preferred embodiment the support tooling itself can also be translated in various axes to assure proper support of the instrument as it is being ground. The stock is then rotated about its longitudinal axis. A form-dressed rotating grinding wheel is then brought into contact with the leading end of the rotating stock to form the tip of the instrument. Next the grinding wheel is retracted to the proper depth, and a retraction and linear feed rate is engaged proportional to the rpm of the rotating stock and the surface speed of the grinding wheel to produce the desired diameter, taper and finish of the tapered diameter of the part. As the tapered part feeds past the grinding wheel it travels into the tapered support section of the work support. After the tapered portion is completed, a second grinding wheel with appropriate form is properly oriented above the supported tapered part, and then fed into the stationary tapered part to produce the desired flute form and depth. The grinding wheel is then retracted and the tapered part is repositioned radially and/or axially so that it is properly oriented for the next flute to be ground. This process is repeated until all the desired flutes are ground. Finally, the completed part is parted off at the same time as the point the next part is established.

The embodiments disclosed herein are illustrative and exemplary in nature and it will be appreciated that numerous modifications and other embodiments of the instrument disclosed may be devised by those skilled in the art. Therefore, it will be understood that the appended claims are intended to cover all such modifications and embodiments which come within the spirit and scope of the present invention.

What is claimed is:

1. An endodontic instrument for use in performing root canal therapy on a tooth comprising:
a shaft having a longitudinal central axis, a shank portion and an elongated working portion extending from the shank portion along the central axis, the elongated working portion having a proximal end, a distal end, and at least one peripheral surface; and
at least one straight flute formed on at least a portion of the peripheral surface of the working portion, the straight flute forming at least one cutting edge on the peripheral surface.

2. The endodontic instrument of claim 1, wherein at least a portion of the working portion is uniformly tapered.

3. The endodontic instrument of claim 1, wherein at least a portion of the working portion is nonuniformly tapered.

4. The endodontic instrument of claim 1, wherein the at least one straight flute is substantially parallel to the central axis.

5. The endodontic instrument of claim 1, wherein the at least one straight flute comprises a plurality of flute sections disposed on the peripheral surface of the instrument, the plurality of flute sections angularly displaced about the central axis with respect to one another and each flute section having first and second ends defined along the central axis.

6. The endodontic instrument of claim 5, wherein at least one end of a first flute section is disposed along the longitudinal central axis between the first and second ends of a second flute section such that the first and second flute sections overlap longitudinally along the central axis.

7. The endodontic instrument of claim 6, further comprising a gate formed where the first and second flute sections overlap longitudinally, the gate facilitating evacuation of cutting debris.

8. The endodontic instrument of claim 5, wherein the second end of one of the flute sections is substantially adjacent the first end of another of the flute sections.

9. The endodontic instrument of claim 5, wherein at least one non-fluted intermediate section is disposed between the plurality of flute sections.

10. The endodontic instrument of claim 5, wherein the plurality of flute sections each further comprise first and second end surfaces with an intermediate surface disposed therebetween, the end surfaces each disposed in a plane transverse to the intermediate surface.

11. The endodontic instrument of claim 10, wherein at least one end surface is generally perpendicular to the intermediate surface.

12. The endodontic instrument of claim 10, wherein at least one end surface is disposed at an angle θ greater than 90° from the intermediate surface.

13. The endodontic instrument of claim 1, wherein the cutting edge includes at least one notch.

14. The endodontic instrument of claim 13, wherein a helical groove is formed along at least a portion of the working portion to provide the at least one notch on the cutting edge.

15. The endodontic instrument of claim 13, wherein at least one circumferential groove is formed along at least a portion of the working portion to provide the at least one notch on the cutting edge.

16. The endodontic instrument of claim 1, wherein the cutting edge has a negative rake angle.

17. The endodontic instrument of claim 1, wherein the cutting edge has a neutral rake angle.

18. The endodontic instrument of claim 1, wherein the cutting edge has a positive rake angle.

19. The endodontic instrument of claim 1, wherein the cutting edge is oriented at an angle α with respect to the longitudinal central axis.

20. The endodontic instrument of claim 1, further comprising at least one helical flute formed on the peripheral surface of the working portion adjacent the at least one straight flute.

21. An endodontic instrument for use in performing root canal therapy on a tooth comprising:
a shaft having a longitudinal central axis, a shank portion and an elongated working portion extending from the shank portion along the central axis, the elongated working portion having a proximal end, a distal end, and at least one peripheral surface;
at least one straight flute formed on at least a portion of the peripheral surface of the working portion, the straight flute forming at least one cutting edge on the peripheral surface;
wherein the straight flute is formed of a plurality of flute sections disposed on the peripheral surface of the instrument, the plurality of flute sections angularly displaced about the central axis with respect to one another and each flute section having first and second ends defined along the central axis, and first and second end surfaces with an intermediate surface disposed therebetween, the end surfaces each disposed in a plane transverse to the intermediate surface.

22. The endodontic instrument of claim 21, wherein at least one end of a first flute section is disposed along the longitudinal central axis between the first and second ends of a second flute section such that the first and second flute sections overlap longitudinally along the central axis.

23. The endodontic instrument of claim 22, further comprising a gate formed where the first and second flute sections overlap longitudinally, the gate facilitating evacuation of cutting debris.

24. A method of manufacturing an endodontic instrument for use in performing root canal therapy on a tooth comprising the steps of:
feeding stock into custom support tooling to form a shaft having a longitudinal central axis, a shank portion and an elongated working portion extending from the shank portion along the central axis, the elongated working portion having a proximal end, a distal end, and at least one peripheral surface;
grinding at least one straight flute into at least a portion of the peripheral surface of the working portion, the straight flute forming at least one cutting edge on the peripheral surface;
grinding the diameter, taper, and finish of the instrument; and
parting off the instrument from the stock.

25. The method of claim 24, wherein the step of grinding the diameter, taper, and finish of the instrument is performed by a first grinding wheel.

26. The method of claim 25, wherein the step of grinding the at least one straight flute into the instrument is performed by a second grinding wheel.
